(19) United States
(12) Patent Application Publication
(10) Pub. No.: US 2012/0176892 A1
(43) Pub. Date: Jul. 12, 2012

(54) Handover Parameter Control Apparatus and Method, and Computer Program

(75) Inventors: Toshiaki YAMAMOTO, Fujimino-shi (JP); Koichiro Kitagawa, Fujimino-shi (JP); Toshihiko Komine, Fujimino-shi (JP)

(73) Assignee: KDDI Corporation

(21) Appl. No.: 13/342,455

(22) Filed: Jan. 3, 2012

(30) Foreign Application Priority Data
Jan. 12, 2011 (JP) 2011-004182

(51) Int. Cl. H04W 36/00; H04L 12/26

(52) U.S. Cl. 370/221

(57) ABSTRACT

A handover parameter control apparatus in each cell of a cellular system having a condition in which if power received by a mobile terminal from a neighbor base station and power received from an access base station, to which the mobile terminal is connected, have power difference greater than or equal to a threshold, the mobile terminal executes handover from an access cell belonging to the access base station to a neighbor cell belonging to the neighbor base station. The apparatus includes a threshold control weight computation unit that computes a threshold control weight which indicates a threshold control direction so as to reduce handover failures, by using a frequency of first-type handover failure events which reduces by increasing the threshold; and a frequency of second-type handover failure events which reduces by decreasing the threshold; and a threshold determination unit that determines the threshold based on the threshold control weight.

### BACKGROUND OF THE INVENTION

1. Field of the Invention

The present invention relates to a handover parameter control apparatus, a handover parameter control method, and a computer program.

Priority is claimed on Japanese Patent Application No. 2011-004182, filed Jan. 12, 2011, the contents of which are incorporated herein by reference.

2. Description of the Related Art

Recently, in a standardization group called 3GPP (third generation partnership project), standardization for cellular systems (called “LTE (long term evolution) systems”) has been advanced. In an LTE system, a handover process for a mobile terminal to switch the base station which it accesses (called the “access base station” below) is executed after the access base station receives a measurement report (MR) message (abbreviated as “MR”) sent from the mobile terminal The timing when the mobile terminal sends the MR can be controlled using an MR parameter set for the mobile terminal by the access base station. That is, the handover timing of the mobile terminal can be controlled using the MR parameter.

Although multiple types of MRs are defined in correspondence to respective contracts, an MR called “A3MR” is generally used in the handover process. When the following Formula 1 is satisfied during a specific time called TTT (time to trigger), A3MR for a base station n adjacent to an access base station s (the base station n being called the “neighbor base station”) is sent from the mobile terminal to the access base station s (see Non-Patent Document 1):

M(s,n)+Of(s,n)+Oc(s,n)−Hys(s)>M(s,s)+Of(s,s)+Oc(s,s)+Off_{A3}(s) (1)

where s indicates an identifier (ID) of the access base station, and n indicates an identifier (ID) of the neighbor base station.

Additionally, M(s,n) represents reception power (called RSPP (reference signal received power), unit: dBm) or reception quality (called RSRQ (reference signal received quality), unit: dB) for reception of a reference signal which is sent from the neighbor base station n (adjacent to the access base station s) to the mobile terminal.

M(s,s) represents RSPP (dBm) or RSRQ (dB) for reception of a reference signal which is sent from the access base station s to the mobile terminal.

Of(s,n) denotes an offset value set for the neighbor base station n by the access base station s based on an individual frequency.

Of(s,s) denotes an offset value set for the access base station s by the access base station s itself based on an individual frequency.

Oc(s,n) denotes an offset value set for each individual neighbor base station n by the access base station s.

Oc(s,$) denotes an offset value set for the access base station s by the access base station s itself

Hys(s) denotes an offset value called “hysteresis” set for each individual access base station s.

Off_{A3}(s) denotes an offset value peculiar to A3MR, which is set for each individual access base station s.

The above offset values function as handover parameters.

The above Formula (1) is used for determining whether or not a handover execution condition in a cellular system is satisfied, where in the handover execution condition, when the mobile terminal receives power from a neighbor base station n, which is higher than the power received from the relevant access base station s by a power difference which is greater than or equal to a threshold, handover from the cell (called “access cell s”) of the access base station s to the cell (called “neighbor cell n”) of the neighbor base station n is executed. The threshold for the power difference is provided using the offset values in Formula (1). Therefore, the power difference for the handover execution condition (from the access cell s to the neighbor cell n) can be changed by changing the offset values in Formula (1), thereby also changing the handover timing of the mobile terminal from the access cell s to the neighbor cell n.

Such a change in the handover timing of the mobile terminal from the access cell to the neighbor cell can reduce handover failure, and also prevents unnecessary handover. Generally, the handover failure events can be classified into the following three types (see Non-Patent Document 2).

### (1) Too Early HO (Handover)

During the handover process from cell A to cell B or immediately after the handover has succeeded, a radio link failure (RLF) occurs and the mobile terminal accesses the cell A again. This may be caused when the handover timing is too early.

### (2) Too Late HO

While the mobile terminal is connected to cell A or during the handover process from cell A to cell B, an RLF occurs and connection to cell B (different from cell A) is newly established. This may be caused when the handover timing is too late.

### (3) HO to Wrong Cell

During the handover process from cell A to cell B or immediately after the handover has succeeded, an RLF occurs and connection to cell C (different from any of cells A and B) is newly established. In this case, cell B is called a “target cell”, and cell C is called a “reconnection cell”.

In addition, in an unnecessary handover event called a “ping-pong handover”, after a handover event from a cell to another cell, return to the original cell is performed within a specific time. For example, handover is iterated a specific number of times between two cells within a specific time.

Non-Patent Documents 3 and 4 each disclose a technique in which if the frequency (or rate of occurrence) for each handover failure event exceeds a threshold which is predetermined therefor, handover parameter control is executed in accordance with the relevant handover failure event.

Non-Patent Document 1: 3GPP TS 36.331 v9.3.0 2010-06, pp. 72-78

Non-Patent Document 2: 3GPP TS 36.300 v9.4.0 2010-06, pp. 156-157

Non-Patent Document 3: Yuji Kojima et al., “A study of self-optimization of Handover parameters considering the location of mobile station”, B-5-90, 2010 IEICE Communications Society

Non-Patent Document 4: J. Alonso-Rubio, “Self-Optimization for Handover Oscillation Control in LTE”, Network Operations and Management Symposium (NOMS), pp. 950-953, 2010 IEEE

However, in the conventional technique disclosed in the above-described Non-Patent Document 3 or 4, if handover failure events which have opposite control directions for the handover parameter control occur simultaneously in a combination of an access cell and a neighbor cell, sufficient handover parameter control cannot be performed. For example, if the value of a handover parameter is decreased so as to reduce the frequency of occurrence of a handover failure event, the frequency of occurrence of another handover event may increase. Accordingly, the value of the handover parameter alternately increases and decreases for each control operation, which degrades stability.

### SUMMARY OF THE INVENTION

In light of the above circumstances, an object of the present invention is to provide a handover parameter control apparatus, a handover parameter control method, and a computer program, by which stability for the handover parameter control can be improved in consideration of a situation in which handover failure events which have opposite handover parameter control directions occur simultaneously.

Therefore, the present invention provides a handover parameter control apparatus provided in each cell of a cellular system which has a handover condition in which if power received by a mobile terminal from a neighbor base station and power received by the mobile terminal from an access base station, to which the mobile terminal is connected, have a power difference greater than or equal to a threshold, then the mobile terminal executes handover of the mobile terminal from an access cell belonging to the access base station to a neighbor cell belonging to the neighbor base station, the apparatus comprising:

a threshold control weight computation unit that computes a threshold control weight which indicates a control direction for the threshold so as to reduce handover failures, by using:
a frequency of occurrence of first-type handover failure events which reduces by increasing the threshold; and
a frequency of occurrence of second-type handover failure events which reduces by decreasing the threshold; and

a threshold determination unit that determines the threshold based on the threshold control weight.

In a typical example:

the first-type handover failure events include those called “Too early HO” and those called “HO to wrong cell” when the neighbor cell is a cell called “target cell” as a destination of the handover; and

the second-type handover failure events include those called “Too late HO” and those called “HO to wrong cell” when the neighbor cell is a cell called “reconnection cell” to which the mobile terminal is reconnected.

The first-type handover failure events may further include those called “ping-pong handover”.

In a preferable example, the threshold control weight computation unit:

computes for each neighbor cell:
a first weight assigned to each control direction for the first-type handover failure events; and
a second weight assigned to each control direction for the second-type handover failure events;

computes a synthesized weight for each of combinations between the control directions for the threshold with respect to all neighbor cells, by synthesizing the first weight and the second weight for all neighbor cells; and

selects one of said combinations which has the maximum synthesized weight.

For the above typical example, it is possible that:

the greater the failure rate for handover of each neighbor cell, the earlier the execution timing of the threshold control for the relevant neighbor cell; and

for a second neighbor cell which forms a pair relating to the “HO to wrong cell” together with a first neighbor cell, the threshold control weight computation unit computes the threshold control weight for the second neighbor cell based on a control criterion for the “HO to wrong cell” defined in accordance with the control direction of the threshold of the first neighbor cell.

In another preferable example:

the second-type handover failure events include those called “HO to wrong cell” when the neighbor cell is a cell called “reconnection cell” to which the mobile terminal is reconnected; and

the threshold control weight computation unit computes the threshold control weight by setting the frequency of occurrence of “HO to wrong cell” to 0.

In another typical example, the threshold determination unit updates the threshold so as to reduce ping-pong handover only when the threshold control weight is assigned to a control direction for increasing the threshold.

In this case, it is possible that:

the higher the frequency of occurrence of the ping-pong handover for each neighbor cell, the earlier the execution timing of the threshold control for the relevant neighbor cell so as to reduce the ping-pong handover; and

for a second neighbor cell which forms a pair relating to the “HO to wrong cell” together with a first neighbor cell, the threshold control weight computation unit computes the threshold control weight for the second neighbor cell based on a control criterion for the “HO to wrong cell” defined in accordance with the control direction of the threshold of the first neighbor cell.

The present invention also provides a handover parameter control method of controlling a handover parameter for each cell of a cellular system which has a handover condition in which if power received by a mobile terminal from a neighbor base station and power received by the mobile terminal from an access base station, to which the mobile terminal is connected, have a power difference greater than or equal to a threshold, then the mobile terminal executes handover of the mobile terminal from an access cell belonging to the access base station to a neighbor cell belonging to the neighbor base station, the method comprising:

a step that is executed by a threshold control weight computation unit and computes a threshold control weight which indicates a control direction for the threshold so as to reduce handover failures, by using:
a frequency of occurrence of first-type handover failure events which reduces by increasing the threshold; and
a frequency of occurrence of second-type handover failure events which reduces by decreasing the threshold; and

a step that is executed by a threshold determination unit and determines the threshold based on the threshold control weight.

The present invention also provides a non-transitory computer-readable storage medium which stores a computer program used for executing a procedure of controlling a handover parameter for each cell of a cellular system which has a handover condition in which if power received by a mobile terminal from a neighbor base station and power received by the mobile terminal from an access base station, to which the mobile terminal is connected, have a power difference greater than or equal to a threshold, then the mobile terminal executes handover of the mobile terminal from an access cell belonging to the access base station to a neighbor cell belonging to the neighbor base station, the program making a computer execute:

a step that computes a threshold control weight which indicates a control direction for the threshold so as to reduce handover failures, by using:
a frequency of occurrence of first-type handover failure events which reduces by increasing the threshold; and
a frequency of occurrence of second-type handover failure events which reduces by decreasing the threshold; and

a step that determines the threshold based on the threshold control weight.

Accordingly, the above-described handover parameter control apparatus can be implemented using a computer.

In accordance with the present invention, stability for the handover parameter control can be improved in consideration of a situation in which handover failure events which have opposite handover parameter control directions occur simultaneously.

### BRIEF DESCRIPTION OF THE DRAWINGS

FIG. 1 is a schematic diagram showing an example structure of a cellular system relating to an embodiment of the present invention.

FIG. 2 is a diagram showing the structure of the handover parameter control apparatus 10 in the embodiment.

FIG. 3 is a flowchart showing Example 1 of the handover parameter control procedure for the embodiment.

FIG. 4 is also a flowchart showing Example 1 of the handover parameter control procedure for the embodiment.

FIG. 5 is a flowchart showing Example 2 of the handover parameter control procedure for the embodiment.

FIG. 6 is a flowchart showing a first example of the handover failure reduction process for step S40 of FIG. 5.

FIG. 7 is a flowchart showing a second example of the handover failure reduction process for step S40 of FIG. 5.

FIG. 8 is a flowchart showing a second example of the ping-pong handover reduction process for step S50 of FIG. 5.

FIG. 9 is a flowchart showing Example 3 of the handover parameter control procedure for the embodiment.

FIG. 10 is a flowchart showing an example of the handover failure reduction process for step S80 of FIG. 9.

### DETAILED DESCRIPTION OF THE INVENTION

Hereinafter, embodiments of the present invention will be described with reference to the appended figures.

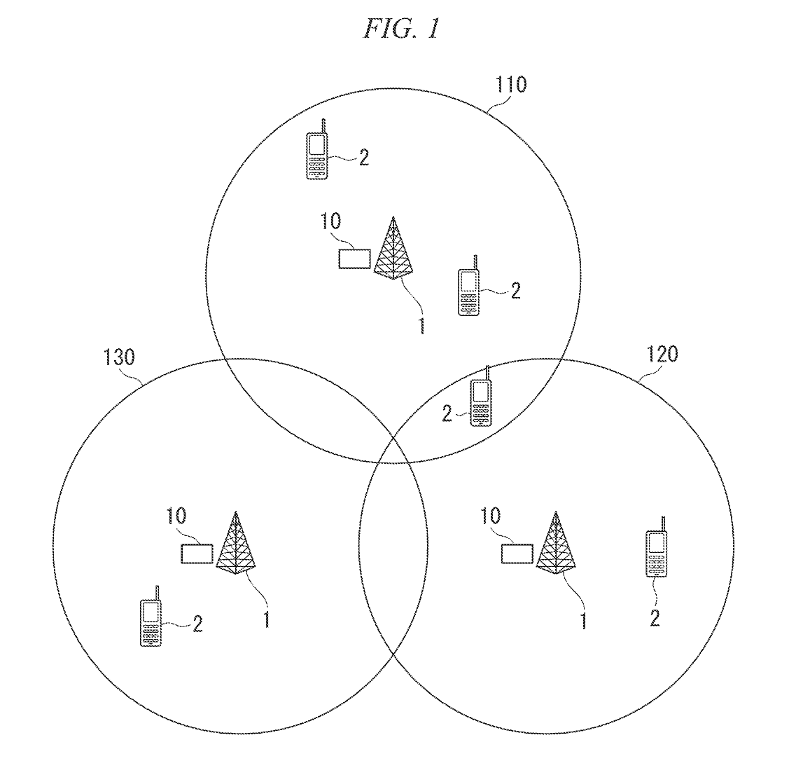

FIG. 1 is a schematic diagram showing an example structure of a cellular system relating to an embodiment of the present invention. The present embodiment employs an LTE (long term evolution) system as an example of the cellular system.

In FIG. 1, three base stations are assigned to cells 110, 120, and 130. A handover parameter control apparatus 10 is provided in each of the cells 110, 120, and 130, and communicates data with the base station 1 of the present cell. The handover parameter control apparatus 10 may be independently constituted, or be built in the relevant base station 1.

A mobile terminal 2 radio-communicates with each base station 1. The mobile terminal 2 performs determination using the above Formula (1), and sends an A3MR to the connected base station when Formula (1) is satisfied. The A3MR transmission functions as a trigger for handover of the mobile terminal 2 from the access cell s to a neighbor cell n. The various offset values in Formula (1) are communicated from the access base station s (i.e., base station 1 to which the mobile terminal 2 is connected) to the mobile terminal 2. The mobile terminal 2 uses the communicated offset values so as to form the above Formula (1).

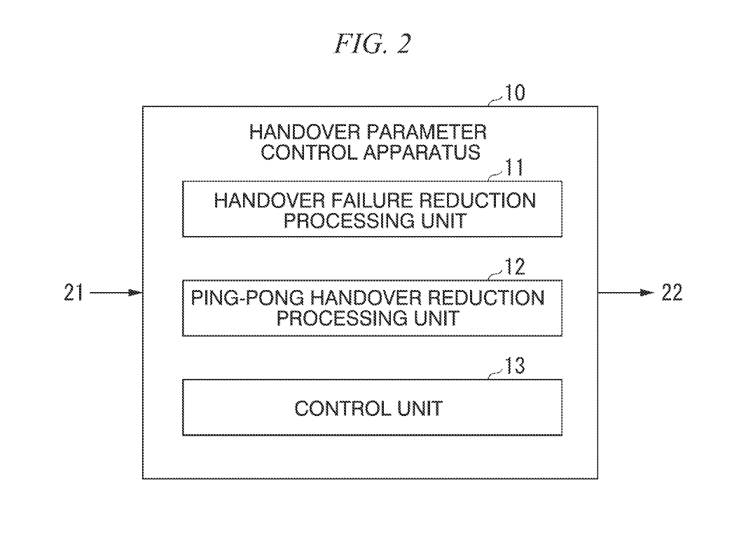

FIG. 2 is a diagram showing the structure of the handover parameter control apparatus 10 in the present embodiment.

In FIG. 2, the handover parameter control apparatus 10 has a handover failure reduction processing unit 11, a ping-pong handover reduction processing unit 12, and a control unit 13.

Input data 21 is supplied from the base station 1 of the present cell to the handover parameter control apparatus 10. The handover parameter control apparatus 10 performs a handover parameter control operation, and outputs output data 22 to the base station 1 of the present cell.

The input data 21 contains the frequency of occurrence of each handover failure event that occurred in the present cell (i.e., access cell s), where the frequency is counted within a specific period. In the present embodiment, the following five handover failure events are used.
(1) “Too early HO” to neighbor cell n
(2) “Too late HO” to neighbor cell n
(3) “HO to wrong cell” when the neighbor cell n is the “target cell”
(4) “HO to wrong cell” when the neighbor cell n is the “reconnection cell”
(5) ping-pong handover for the neighbor cell n

In the present embodiment, a threshold used for determination about the power difference “M(s,n)−M(s,s)” is controlled so as to reduce the frequency of occurrence of the above five handover failure events.

For the above events (1) (“Too early HO” to neighbor cell n) and (3) (“HO to wrong cell” when the neighbor cell n is the “target cell”), each frequency can be reduced by providing a relatively large threshold for the power difference “M(s,n)−M(s,s)”, where the events (1) and (3) will be called “first-type handover failure events”.

In contrast, for the above events (2) (“Too late HO” to neighbor cell n) and (4) (“HO to wrong cell” when the neighbor cell n is the “reconnection cell”), each frequency can be reduced by providing a relatively small threshold for the power difference “M(s,n)−M(s,s)”, where the events (2) and (4) will be called “second-type handover failure events”.

Additionally, the frequency of occurrence of the above event (5) (ping-pong handover for the neighbor cell n) can be reduced by providing a relatively large threshold for the power difference “M(s,n)−M(s,s)”.

The handover failure reduction processing unit 11 uses the input data 21 so as to perform a handover parameter control procedure for reducing the frequency of occurrence of the handover failure events belonging to the first-type and second-type handover failure events. The ping-pong handover reduction processing unit 12 also uses the input data 21 so as to perform a handover parameter control procedure for reducing the frequency of occurrence of the ping-pong handover. The control unit 13 controls the handover failure reduction processing unit 11 and the ping-pong handover reduction processing unit 12.

In the above structure, the ping-pong handover reduction processing unit 12 may be omitted. In this case, ping-pong handover may be assigned to the first-type handover failure events so that the frequency of occurrence of the ping-pong handover can be reduced using the handover failure reduction processing unit 11.

The output data 22 as a result of the handover parameter control operation is used for determining each threshold for the power difference “M(s,n)−M(s,s)” for Formula (1), and the threshold is constituted using the six offset values Of(s,n), Of(s,s), Oc(s,n), Oc(s,s), Hys(s), and Off_{A3}(s). In the present embodiment, among the above six thresholds, Oc(s,n) is controlled, which is an offset value set for each individual neighbor base station n by the base station 1 of the present cell (i.e., the access base station s). Therefore, the handover parameter control apparatus 10 in the present embodiment controls Oc(s,n) for each neighbor base station n (i.e., each neighbor cell n).

In the above Formula (1), Oc(s,n) is present on the left side of the formula similar to M(s,n), and has a positive sign. Therefore, in order to apply a relatively large threshold to the power difference “M(s,n)−M(s,s)” in Formula (1), Oc(s,n) is set to a relatively small value. In contrast, in order to provide a relatively small threshold, Oc(s,n) is set to a relatively large value.

The handover parameter control apparatus 10 of the present embodiment also controls Off_{A3}(s) if necessary. Off_{A3}(s) is an offset value peculiar to A3MR, and is set for each individual access base station s.

Below, the operation of the handover parameter control apparatus 10 in the present embodiment will be explained in detail for each example.

### EXAMPLE 1

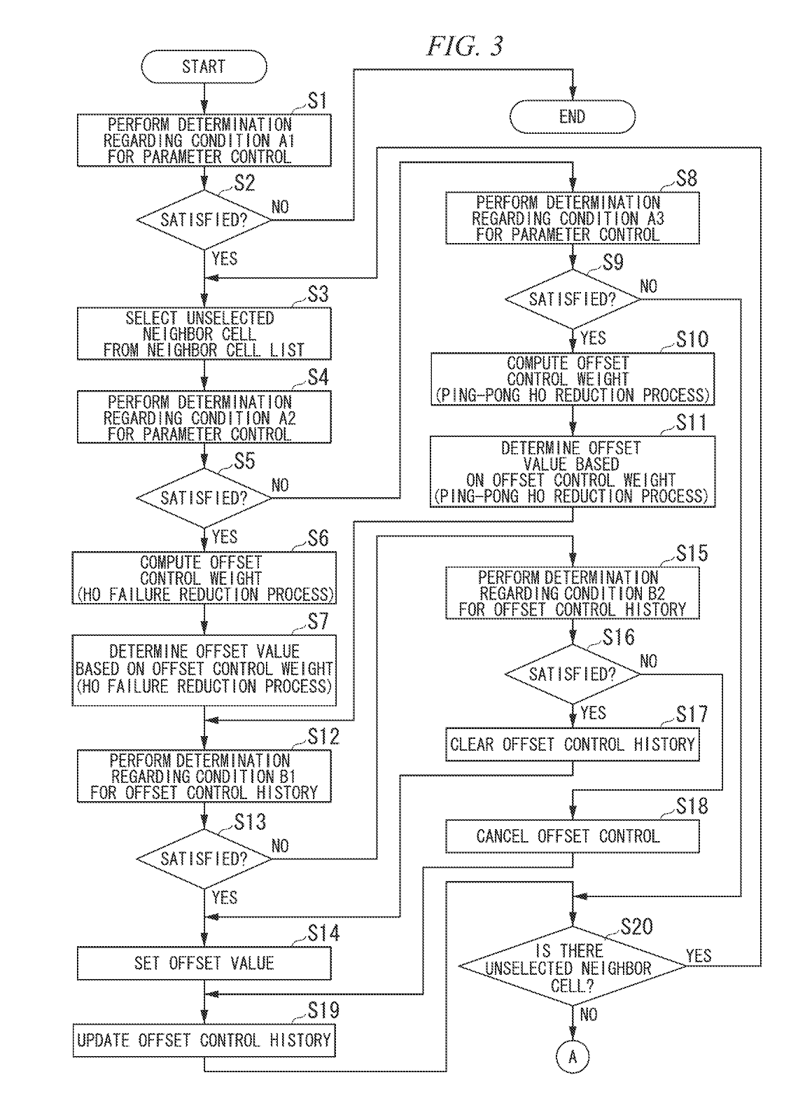

FIGS. 3 an 4 show Example 1 of the handover parameter control procedure for the present embodiment.

In Example 1, an offset control weight which indicates the control direction for Oc(s,n) is defined by Formula (2).

offset control weight=−(w1×(frequency of occurrence of “Too Early HO”)+b1)+

(w2×(frequency of occurrence of “Too Late HO”)+b2)−

(w3×(frequency of occurrence of “HO to wrong cell” having neighbor cell n as “target cell”)+b3)+

(w4×(frequency of occurrence of “HO to wrong cell” having neighbor cell n as “reconnection cell”)+b4) (2)

where w1, w2, w3, w4, b1, b2, b3, and b4 are real numbers.

When performing the handover parameter control, the degree of consideration of each handover failure event can be controlled by appropriately setting the values of w1, w2, w3, w4, b1, b2, b3, and b4. For example, when w3, b3, w4, and b4 are each set to 0, “HO to wrong cell” is not considered while only “Too Early HO” and “Too late HO” are considered so as to implement the parameter control for reducing the failure rate for handover.

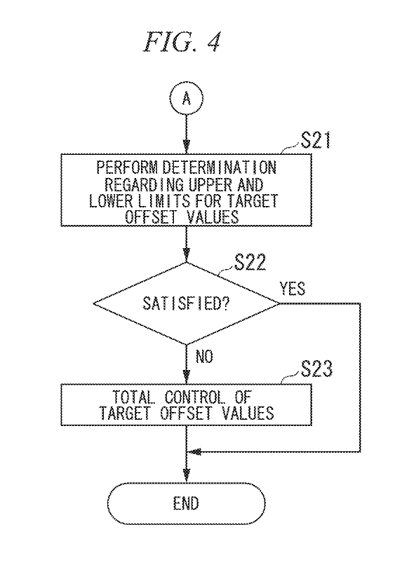

Referring to FIGS. 3 and 4, Example 1 of the handover parameter control procedure in the present embodiment will be explained. The control unit 13 starts the handover parameter control procedure shown in FIGS. 3 and 4 at regular periodic intervals.

Step S1: The control unit 13 performs a determination regarding a condition Al for executing the parameter control. This condition A1 is satisfied when any one of the followings is satisfied: (i) handover failure rate in the present cell is greater than or equal to a predetermined value (x1%), (ii) failure rate of handover to each individual neighbor cell is greater than or equal to a predetermined value (x2%), and (iii) frequency of occurrence of ping-pong handover for each individual neighbor cell is greater than or equal to a predetermined number (z).

Step S2: When the execution condition Al is satisfied according to the determination of step S1, the control unit 13 then performs step S3. When the execution condition A1 is not satisfied, the control unit 13 terminates the handover parameter control procedure in FIGS. 3 and 4.

Step S3: The control unit 13 selects one neighbor cell which is included in a neighbor cell list (called “neighbor list”) and has not yet been selected. The neighbor list includes IDs of neighbor cells.

Step S4: For the neighbor cell n selected in step S3, the control unit 13 performs a determination regarding a condition A2 for executing the parameter control. This condition A2 is satisfied when any one of the followings is satisfied for handover between the present cell and the neighbor cell n: (i) the frequency of occurrence of the handover is greater than or equal to a predetermined number (y1) and the relevant handover failure rate is greater than or equal to a predetermined value (x3%), and (ii) the frequency of occurrence of the handover is small than the predetermined number (y1) and the frequency of occurrence of handover failure is greater than or equal to a predetermined number (y2).

Step S5: When the execution condition A2 is satisfied according to the determination of step S4, the control unit 13 then performs step S6. When the execution condition A2 is not satisfied, the control unit 13 performs step S8.

Step S6: The handover failure reduction processing unit 11 computes the offset control weight for the neighbor cell n by using the above Formula (2).

Step S7: The handover failure reduction processing unit 11 determines Oc(s,n) based on the offset control weight applied to the neighbor cell n.

A method of determining Oc(s,n) in step S7 will be explained. First, a constant c as a real number of 0 or greater is set in advance. When the offset control weight is greater than the constant c, Oc(s,n) is increased from the current value. When the offset control weight is less than or equal to the constant c but greater than “−c”, the current value of Oc(s,n) is maintained. When the offset control weight is less than “−c”, Oc(s,n) is decreased from the current value. The variation width of Oc(s,n) may be fixed, or valuable in accordance with the offset control weight.

Step S8: For the neighbor cell n selected in step S3, the control unit 13 performs a determination regarding a condition A3 for executing the parameter control. This condition A3 is satisfied when the frequency of occurrence of ping-pong handover between the present cell and the neighbor cell n is greater than or equal to the predetermined number (z).

Step S9: When the execution condition A3 is satisfied according to the determination of step S8, the control unit 13 then performs step S10. When the execution condition A3 is not satisfied, the control unit 13 performs step S20.

Step S10: The ping-pong handover reduction processing unit 12 computes the offset control weight for the neighbor cell n by using the above Formula (2).

Step S11: The ping-pong handover reduction processing unit 12 determines Oc(s,n) based on the offset control weight applied to the neighbor cell n.

A method of determining Oc(s,n) in step S11 will be explained. First, a constant c as a real number of 0 or greater is set in advance. When the offset control weight is less than “−c”, Oc(s,n) is decreased from the current value. When the offset control weight is greater than or equal to “−c”, the current value of Oc(s,n) is maintained. The variation width of Oc(s,n) may be fixed, or valuable in accordance with the offset control weight.

Step S12: For the neighbor cell n, the control unit 13 performs a determination regarding a condition B1 relating to offset control history. This condition B1 is satisfied when no control direction change was performed in a predetermined number of most recently past Oc(s,n) control operations.

Step S13: When the condition B1 for offset control history is satisfied according to the determination of step S12, the control unit 13 then performs step S14. When the condition B1 is not satisfied, the control unit 13 performs step S15.

Step S14: The control unit 13 sets the output data 22 to Oc(s,n) which was determined in step S7 or S11 for the neighbor cell n. Then, the control unit 13 performs step S19. In the present step S14, although the output data 22 is set to Oc(s,n), the output data 22 is not output yet.

Step S15: For the neighbor cell n, the control unit 13 performs a determination regarding a condition B2 relating to the offset control history. This condition B2 is satisfied when a predetermined number of immediately past consecutive Oc(s,n) control operations were cancelled.

Step S16: When the condition B2 for offset control history is satisfied according to the determination of step S15, the control unit 13 then performs step S17. When the condition B2 is not satisfied, the control unit 13 performs step S18.

Step S17: The control unit 13 clears the offset control history of the neighbor cell n, and then performs step S14.

Step S18: The control unit 13 cancels the current offset control of Oc(s,n) for the neighbor cell n, and then performs step S19.

Step S19: The control unit 13 updates the offset control history of the neighbor cell n.

Step S20: The control unit 13 determines whether or not the neighbor list still includes an unselected neighbor cell. When there is an unselected neighbor cell according to the determination, the operation returns to step S3. When there is no unselected neighbor cell in the neighbor list, the operation proceeds to step S21 in FIG. 4.

Step S21: For all Oc(s,n) values set as output data 22, the control unit 13 determines whether or not the Oc(s,n) values are within a range between specific lower and upper limits.

Step S22: When all Oc(s,n) values (set as output data 22) satisfy the relevant lower and upper limit conditions according to the determination of step S21, the control unit 13 terminates the handover parameter control procedure shown in FIGS. 3 and 4. If any of the Oc(s,n) values set as the output data 22 does not satisfy the lower or upper limit condition, the operation proceeds to step S23.

Step S23: For all Oc(s,n) values set as output data 22, the control unit 13 performs total control so that the relevant lower and upper limit conditions are satisfied. Specifically, a median of all Oc(s,n) values set as output data 22 is computed, and the value corresponding to the median is shifted to Off_{A3}(s). Then, the value corresponding to the median is extracted from each of all Oc(s,n) values set as output data 22.

After the handover parameter control operation of FIGS. 3 and 4 has completed, the handover parameter control apparatus 10 outputs the output data 22 to the base station 1 of the present cell.

In the above step S23, the total control may be performed using Hys(s) in FIG. 1, or an average may be used instead of the median.

### EXAMPLE 2

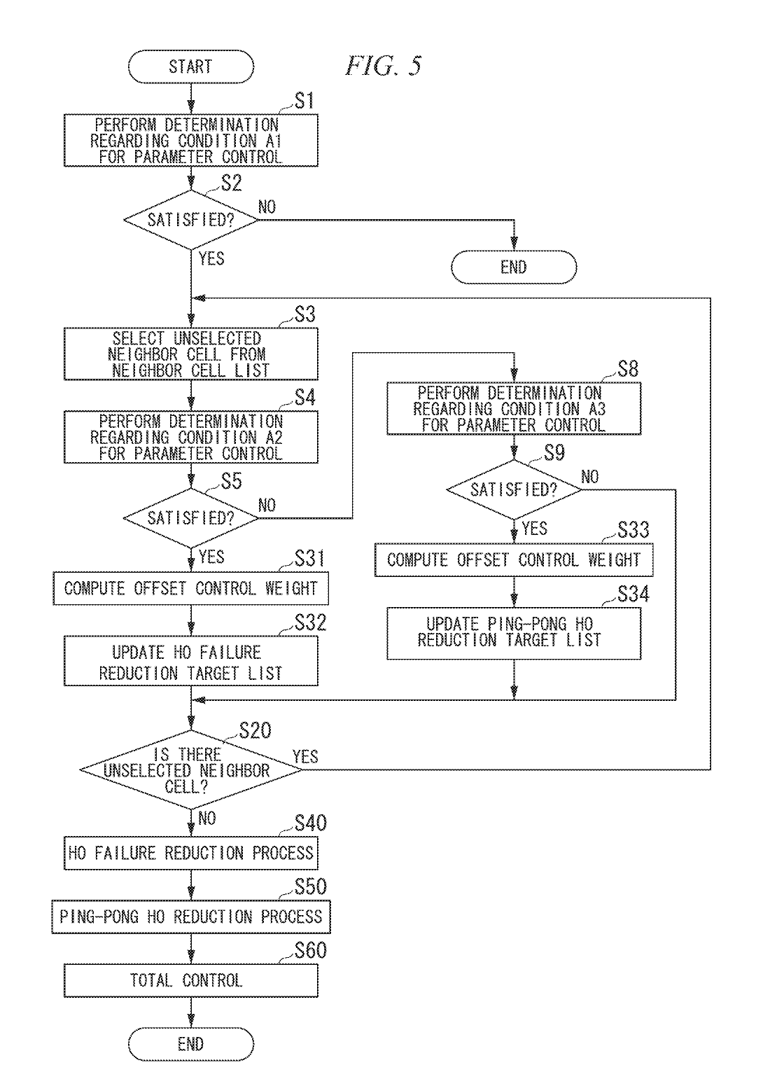

FIG. 5 shows Example 2 of the handover parameter control procedure for the present embodiment. In FIG. 5, steps corresponding to those in FIG. 3 of Example 1 are given identical reference signs.

In Example 2, Oc(s,n) is controlled in consideration of influences imposed between neighbor cells.

Referring to FIG. 5, Example 2 of the handover parameter control procedure in the present embodiment will be explained. The control unit 13 starts the handover parameter control procedure shown in FIG. 5 at regular periodic intervals.

Steps S1 to S5 are basically identical to those of Example 1 (see FIG. 3). In Step S5 of Example 2, when the condition A2 for executing the parameter control is satisfied according to the determination of step S4, the operation proceeds to step S31 or step S32. If proceeding to step S32, step S31 in FIG. 5 is not executed. Whether the operation proceeds to step S31 or S32 is determined in accordance with the content of step S40 (explained later).

Step S31: Similar to Example 1, the handover failure reduction processing unit 11 computes the offset control weight for the neighbor cell n, by using Formula (2).

Step S32: The handover failure reduction processing unit 11 stores the ID of the neighbor cell n selected in step S3 into a handover failure reduction target list, and then performs step S20.

In step S5, when the condition A2 for executing the parameter control is not satisfied according to the determination of step S4, the operation proceeds to step S8, which is identical to Example 1 (see FIG. 3).

Step S9: When the condition A3 for executing the parameter control is satisfied according to the determination of step S8, the control unit 13 then performs step S33. When the condition A3 is not satisfied, the operation proceeds to step S20.

Step S33: Similar to Example 1, the ping-pong handover reduction processing unit 12 computes the offset control weight for the neighbor cell n, by using Formula (2).

Step S34: The ping-pong handover reduction processing unit 12 stores the ID of the neighbor cell n selected in step S3 into a ping-pong handover reduction target list, and then performs step S20.

Step S20: The control unit 13 determines whether or not the neighbor list still includes an unselected neighbor cell. When there is an unselected neighbor cell according to the determination, the operation returns to step S3. When there is no unselected neighbor cell in the neighbor list, the operation proceeds to step S40.

Step S40: A handover failure reduction process is applied to each neighbor cell included in the handover failure reduction target list. This process will be explained later.

Step S50: A ping-pong handover reduction process is applied to each neighbor cell included in the ping-pong handover reduction target list. This process will also be explained later.

Step S60: For all Oc(s,n) values set as output data 22, the control unit 13 performs total control, which is identical to those performed in steps S21 to S23 of Example 1 (see FIG. 4). The operation of FIG. 5 is then terminated.

### First Example of Step S40

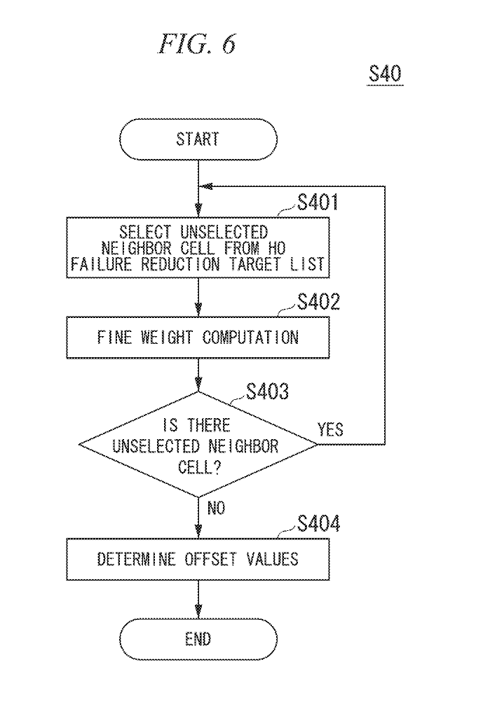

FIG. 6 shows a first example of the handover failure reduction process for step S40 of FIG. 5. Referring to FIG. 6, the first example of the handover failure reduction process in step S40 will be explained.

In the first example of step S40, when the condition A2 for executing the parameter control is satisfied in step S5 (see FIG. 5) according to the determination of step S4, the operation proceeds to step S32, so that step S31 is not executed.

Step S401: The handover failure reduction processing unit 11 selects an unselected neighbor cell from the handover failure reduction target list.

Step S402: The handover failure reduction processing unit 11 performs a fine weight computation for the neighbor cell n selected in step S401.

The fine weight computation of step S402 will be explained. As described below, in the fine weight computation executed for the neighbor cell n, individual weights assigned to all control directions of Oc(s,n) are computed for each of the above handover failure events (1) to (4). There are three control directions for Oc(s,n), which are increasing from the current value, decreasing from the current value, and maintaining the current value.

(1) Computation of weight “We,n” for “Too Early HO” to neighbor cell n

In order to increase Oc(s,n) from the current value, We,n is computed as:

We,n=−(frequency of occurrence of “Too early HO” to neighbor cell n)

In order to decrease Oc(s,n) from the current value, We,n is computed as:

We,n=+(frequency of occurrence of “Too early HO” to neighbor cell n)

In order to maintain the current Oc(s,n), We,n is computed as:

We,n=0

(2) Computation of weight “W1,n” for “Too Late HO” to neighbor cell n

In order to increase Oc(s,n) from the current value, W1,n is computed as:

W1,n=+(frequency of occurrence of “Too late HO” to neighbor cell n)

In order to decrease Oc(s,n) from the current value, W1,n is computed as:

W1,n=−(frequency of occurrence of “Too late HO” to neighbor cell n)

In order to maintain the current Oc(s,n), W1,n is computed as:

W1,n=0

(3) Computation of weight “Wwt,n,r” for “HO to wrong cell” when the neighbor cell n is the “Target Cell”

Here, the neighbor cell as a candidate for the “reconnection cell” is denoted as “r”. The following j1 and j2 are positive real numbers, where j1 is less than or equal to j2.

(3-1) In order to increase Oc(s,n) for the neighbor cell n from the current value and also increase Oc(s,r) for the neighbor cell r from the current value, Wwt,n,r is computed as:

Wwt,n,r=0

(3-2) In order to increase Oc(s,n) for the neighbor cell n from the current value and maintain the current Oc(s,r) for the neighbor cell r, Wwt,n,r is computed as:

Wwt,n,r=j1×(frequency of occurrence of “HO to wrong cell” when the neighbor cell n is the target cell and the neighbor cell r is the reconnection cell)

(3-3) In order to increase Oc(s,n) for the neighbor cell n from the current value and decrease Oc(s,r) for the neighbor cell r from the current value, Wwt,n,r is computed as:

Wwt,n,r=−j2×(frequency of occurrence of “HO to wrong cell” when the neighbor cell n is the target cell and the neighbor cell r is the reconnection cell)

(3-4) In order to maintain the current Oc(s,n) for the neighbor cell n and increase Oc(s,r) for the neighbor cell r from the current value, Wwt,n,r is computed as:

Wwt,n,r=j1×(frequency of occurrence of “HO to wrong cell” when the neighbor cell n is the target cell and the neighbor cell r is the reconnection cell)

(3-5) In order to maintain the current Oc(s,n) for the neighbor cell n and also maintain the current Oc(s,r) for the neighbor cell r, Wwt,n,r is computed as:

Wwt,n,r=0

(3-6) In order to maintain the current Oc(s,n) for the neighbor cell n and decrease Oc(s,r) for the neighbor cell r from the current value, Wwt,n,r is computed as:

Wwt,n,r=−j1×(frequency of occurrence of “HO to wrong cell” when the neighbor cell n is the target cell and the neighbor cell r is the reconnection cell)

(3-7) In order to decrease Oc(s,n) for the neighbor cell n from the current value and increase Oc(s,r) for the neighbor cell r from the current value, Wwt,n,r is computed as:

Wwt,n,r=j2×(frequency of occurrence of “HO to wrong cell” when the neighbor cell n is the target cell and the neighbor cell r is the reconnection cell)

(3-8) In order to decrease Oc(s,n) for the neighbor cell n from the current value and maintain the current Oc(s,r) for the neighbor cell r, Wwt,n,r is computed as:

Wwt,n,r=j1×(frequency of occurrence of “HO to wrong cell” when the neighbor cell n is the target cell and the neighbor cell r is the reconnection cell)

(3-9) In order to decrease Oc(s,n) for the neighbor cell n from the current value and also decrease Oc(s,r) for the neighbor cell r from the current value, Wwt,n,r is computed as:

Wwt,n,r=0

(4) Computation of weight “Wwr,n,t” for “HO to wrong cell” when the neighbor cell n is the “reconnection cell”

Here, the neighbor cell as a candidate for the “target cell” is denoted as “t”. The following j1 and j2 are positive real numbers, where j1 is less than or equal to j2.

(4-1) In order to increase Oc(s,n) for the neighbor cell n from the current value and also increase Oc(s,t) for the neighbor cell t from the current value, Wwr,n,t is computed as:

Wwr,n,t=0

(4-2) In order to increase Oc(s,n) for the neighbor cell n from the current value and maintain the current Oc(s,t) for the neighbor cell t, Wwr,n,t is computed as:

Wwr,n,t=j1×(frequency of occurrence of “HO to wrong cell” when the neighbor cell n is the reconnection and the neighbor cell t is the target cell)

(4-3) In order to increase Oc(s,n) for the neighbor cell n from the current value and decrease Oc(s,t) for the neighbor cell t from the current value, Wwr,n,t is computed as:

Wwr,n,t=j2×(frequency of occurrence of “HO to wrong cell” when the neighbor cell n is the reconnection and the neighbor cell t is the target cell)

(4-4) In order to maintain the current Oc(s,n) for the neighbor cell n and increase Oc(s,t) for the neighbor cell t from the current value, Wwr,n,t is computed as:

Wwr,n,t=−j1×(frequency of occurrence of “HO to wrong cell” when the neighbor cell n is the reconnection and the neighbor cell t is the target cell)

(4-5) In order to maintain the current Oc(s,n) for the neighbor cell n and also maintain the current Oc(s,t) for the neighbor cell t, Wwr,n,t is computed as:

Wwr,n,t=0

(4-6) In order to maintain the current Oc(s,n) for the neighbor cell n and decrease Oc(s,t) for the neighbor cell t from the current value, Wwr,n,t is computed as:

Wwr,n,t=j1×(frequency of occurrence of “HO to wrong cell” when the neighbor cell n is the reconnection and the neighbor cell t is the target cell)

(4-7) In order to decrease Oc(s,n) for the neighbor cell n from the current value and increase Oc(s,t) for the neighbor cell t from the current value, Wwr,n,t is computed as:

Wwr,n,t=−j2×(frequency of occurrence of “HO to wrong cell” when the neighbor cell n is the reconnection and the neighbor cell t is the target cell)

(4-8) In order to decrease Oc(s,n) for the neighbor cell n from the current value and maintain the current Oc(s,t) for the neighbor cell t, Wwr,n,t is computed as:

Wwr,n,t=−j1×(frequency of occurrence of “HO to wrong cell” when the neighbor cell n is the reconnection and the neighbor cell t is the target cell)

(4-9) In order to decrease Oc(s,n) for the neighbor cell n from the current value and also decrease Oc(s,t) for the neighbor cell t from the current value, Wwr,n,t is computed as:

Wwr,n,t=0

The above is the explanation of the fine weight computation performed in step

S402.

Step S403: The handover failure reduction processing unit 11 determines whether or not the handover failure reduction target list still includes an unselected neighbor cell. When an unselected neighbor cell remains in the handover failure reduction target list, the operation returns to step S401. When there is no unselected neighbor cell in the handover failure reduction target list, the operation proceeds to step S404.

Step S404: The handover failure reduction processing unit 11 computes a synthesized weight W using Formula (3) for each combination between the control directions of Oc(s,n) where all neighbor cells included in the handover failure reduction target list are targeted in the computation.

W=Σₙ(We,n+W1,n+Wwt,n,r+ΣₜWwr,n,t) (3)

From among the combinations between the control directions of Oc(s,n) (where all neighbor cells included in the handover failure reduction target list are considered), a combination having the maximum synthesized weight W is selected by the handover failure reduction processing unit 11, thereby determining the control direction of Oc(s,n) for each neighbor cell in the handover failure reduction target list. Then, for each neighbor cell in the handover failure reduction target list, the handover failure reduction processing unit 11 determines Oc(s,n) in accordance with each control condition of Oc(s,n). The method of determining Oc(s,n) is identical to those in step S7 of Example 1 (see FIG. 3).

### Second Example of Step S40

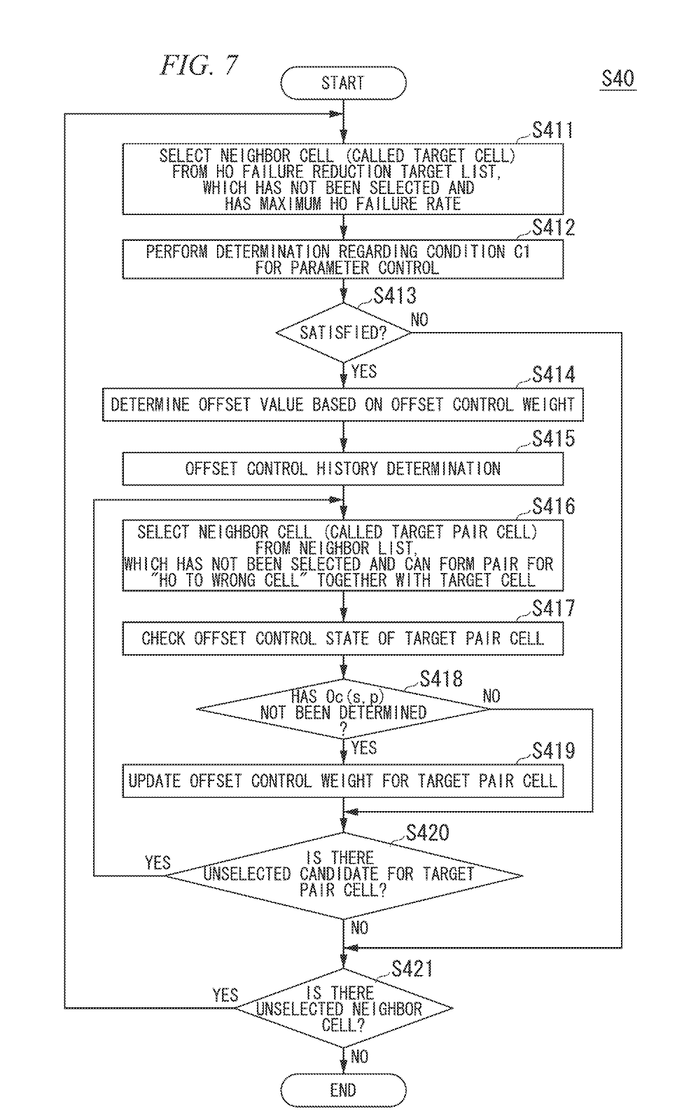

FIG. 7 shows a second example of the handover failure reduction process for step S40 of FIG. 5. Referring to FIG. 7, the second example of the handover failure reduction process in step S40 will be explained.

In the second example of step S40, when the condition A2 for executing the parameter control is satisfied in step S5 (see FIG. 5) according to the determination of step S4, the operation proceeds to step S31. Since step S31 in FIG. 5 is identical to step S6 of Example 1 (see FIG. 3), the handover failure reduction processing unit 11 computes the offset control weight for the neighbor cell n by using the above Formula (2). The offset control weight for each neighbor cell obtained by step S31 is stored as an initial value of the relevant offset control weight.

Step S411: The handover failure reduction processing unit 11 selects a neighbor cell from the handover failure reduction target list, which has not yet been selected and has the maximum failure rate for handover. The selected neighbor cell will be called “target cell n”.

Step S412: For the target cell, the handover failure reduction processing unit 11 performs a determination regarding a condition C1 for executing the parameter control.

This condition C1 is satisfied when the most recent value of the offset control weight for the target cell n has the same sign as that of the value obtained in step S31 (i.e., initial value).

Step S413: When the execution condition C1 is satisfied according to the determination of step S412, the handover failure reduction processing unit 11 then performs step S414. When the execution condition C1 is not satisfied, the operation proceeds to step S421.

Step S414: Based on the offset control weight for the target cell n, the handover failure reduction processing unit 11 determines Oc(s,n) for the target cell n. The method of determining Oc(s,n) is identical to that performed in step S7 of Example 1 (see FIG. 3).

Step S415: The control unit 13 performs an offset control history determination process which is similar to those performed in steps S12 to S19 of Example 1 (see FIG. 3).

Step S416: The handover failure reduction processing unit 11 selects a neighbor cell from the neighbor (cell) list, which has not yet been selected and can form a pair for “HO to wrong cell” together with the target cell n. The selected neighbor cell will be called “target pair cell p”.

Step S417: The handover failure reduction processing unit 11 checks the offset control state of the target pair cell p.

Step S418: According to the check performed in step S417, when Oc(s,p) for the target pair cell p has been determined, the handover failure reduction processing unit 11 then performs step S420. When Oc(s,p) for the target pair cell p has not yet been determined, the operation proceeds to step S419.

Step S419: The handover failure reduction processing unit 11 updates the offset control weight for the target pair cell p.

The method of updating the offset control weight in step S419 will be explained. In the relevant method for the target cell n and the target pair cell p, the offset control weight for the target pair cell p is updated based on the following control criteria (a) and (b) relating to “HO to wrong cell”, which are defined in consideration of the control direction for Oc(s,n) of the target cell n. The updated value functions as the most recent value of the offset control weight for the target pair cell p. Additionally, k1 is a positive real number.

(a) When the control direction for Oc(s,n) of the target cell n is to increase from the current value, “k1×(w3×(frequency of occurrence of “HO to wrong cell” when the target pair cell p is the “target cell” and the target cell n is the “reconnection cell”)+b3)” is subtracted from the offset control weight for the target pair cell p.

(b) When the control direction for Oc(s,n) of the target cell n is to decrease from the current value, “k1×(w4×(frequency of occurrence of “HO to wrong cell” when the target cell n is the target cell and the target pair cell p is the reconnection cell)+b4)” is subtracted from the offset control weight for the target pair cell p.

Step S420: The handover failure reduction processing unit 11 determines whether or not the neighbor list includes an unselected candidate for the target pair cell. When the neighbor list still includes an unselected candidate for the target pair cell, the operation returns to step S416. When there is no unselected candidate for the target pair cell in the neighbor list, the operation proceeds to step S421.

Step S421: The handover failure reduction processing unit 11 determines whether or not the handover failure reduction target list includes an unselected neighbor cell. When the handover failure reduction target list still includes an unselected neighbor cell, the operation returns to step S411. When there is no unselected neighbor cell in the handover failure reduction target list, the operation of FIG. 7 is terminated.

### First Example of Step S50

A first example of the ping-pong handover reduction process for step S50 of FIG. 5 is applied to each neighbor cell included in the ping-pong handover reduction target list. Similar to step S11 of Example 1 (see FIG. 3), in the relevant method, Oc(s,n) for the neighbor cell n is determined based on the offset control weight for the neighbor cell n. Then, an offset control history determination process similar to steps S12 to 19 of Example 1 (see FIG. 3) is performed.

### Second Example of Step S50

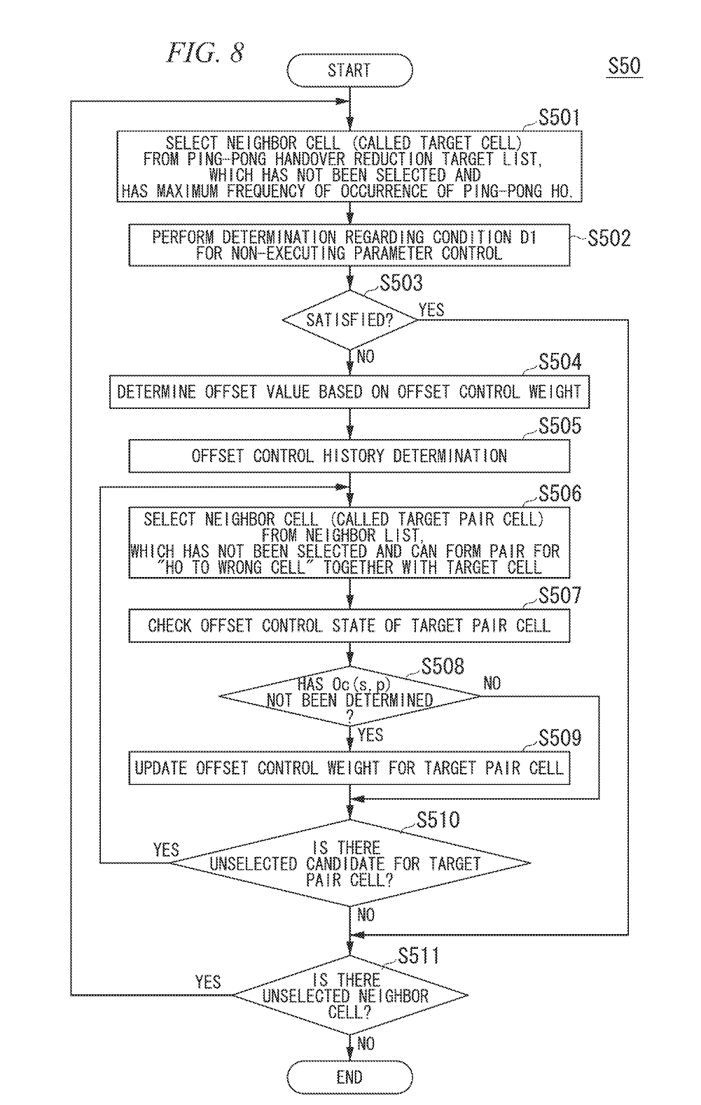

FIG. 8 shows a second example of the ping-pong handover reduction process for step S50 of FIG. 5. Referring to FIG. 8, the second example of the ping-pong handover reduction process in step S50 will be explained.

Step S501: The ping-pong handover reduction processing unit 12 selects a neighbor cell from the ping-pong handover reduction target list, which has not yet been selected and has the maximum frequency for ping-pong handover. The selected neighbor cell will be called “target cell n”.

Step S502: For the target cell n, the ping-pong handover reduction processing unit 12 performs a determination regarding a condition D1 for non-executing the parameter control. This condition D1 is satisfied when (i) the offset control weight for the target cell n is not increased in the negative direction from a negative value due to the offset control weight for another neighbor cell which was updated in the ping-pong handover reduction process (see step S50 in FIG. 5), and (ii) the offset control weight for the target cell n has a sign inverse to that of the result of computation of step S33 in FIG. 5 only due to the offset control weight for another neighbor cell which was updated in the relevant ping-pong handover reduction process.

Step S503: When the non-execution condition D1 is satisfied according to the determination of step S502, the ping-pong handover reduction processing unit 12 then performs step S511. When the non-execution condition D1 is not satisfied, the operation proceeds to step S504.

Step S504: Similar to step S11 of Example 1 (see FIG. 3), the ping-pong handover reduction processing unit 12 determines Oc(s,n) of the target cell n based on the offset control weight for the target cell n.

Step S505: The control unit 13 performs an offset control history determination process which is similar to those performed in steps S12 to S19 of Example 1 (see FIG. 3).

Step S506: The ping-pong handover reduction processing unit 12 selects a neighbor cell from the neighbor (cell) list, which has not yet been selected and can form a pair for “HO to wrong cell” together with the target cell n. The selected neighbor cell will be called “target pair cell p”.

Step S507: The ping-pong handover reduction processing unit 12 checks the offset control state of the target pair cell p.

Step S508: According to the check performed in step S507, when Oc(s,p) for the target pair cell p has been determined, the ping-pong handover reduction processing unit 12 then performs step S510. When Oc(s,p) for the target pair cell p has not yet been determined, the operation proceeds to step S509.

Step S509: The ping-pong handover reduction processing unit 12 updates the offset control weight for the target pair cell p.

The method of updating the offset control weight in step S509 will be explained. In the relevant method for the target cell n and the target pair cell p, the offset control weight for the target pair cell p is updated based on the following control criterion (c) relating to “HO to wrong cell”.

(c) “k1×(w4×(frequency of occurrence of “HO to wrong cell” when the target cell n is the “target cell” and the target pair cell p is the “reconnection cell”)+b4)” is subtracted from the offset control weight for the target pair cell p.

Step S510: The ping-pong handover reduction processing unit 12 determines whether or not the neighbor list includes an unselected candidate for the target pair cell. When the neighbor list still includes an unselected candidate for the target pair cell, the operation returns to step S506. When there is no unselected candidate for the target pair cell in the neighbor list, the operation proceeds to step S511.

Step S511: The ping-pong handover reduction processing unit 12 determines whether or not the ping-pong handover reduction target list includes an unselected neighbor cell. When the ping-pong handover reduction target list still includes an unselected neighbor cell, the operation returns to step S501. When there is no unselected neighbor cell in the ping-pong handover reduction target list, the operation of FIG. 8 is terminated.

### EXAMPLE 3

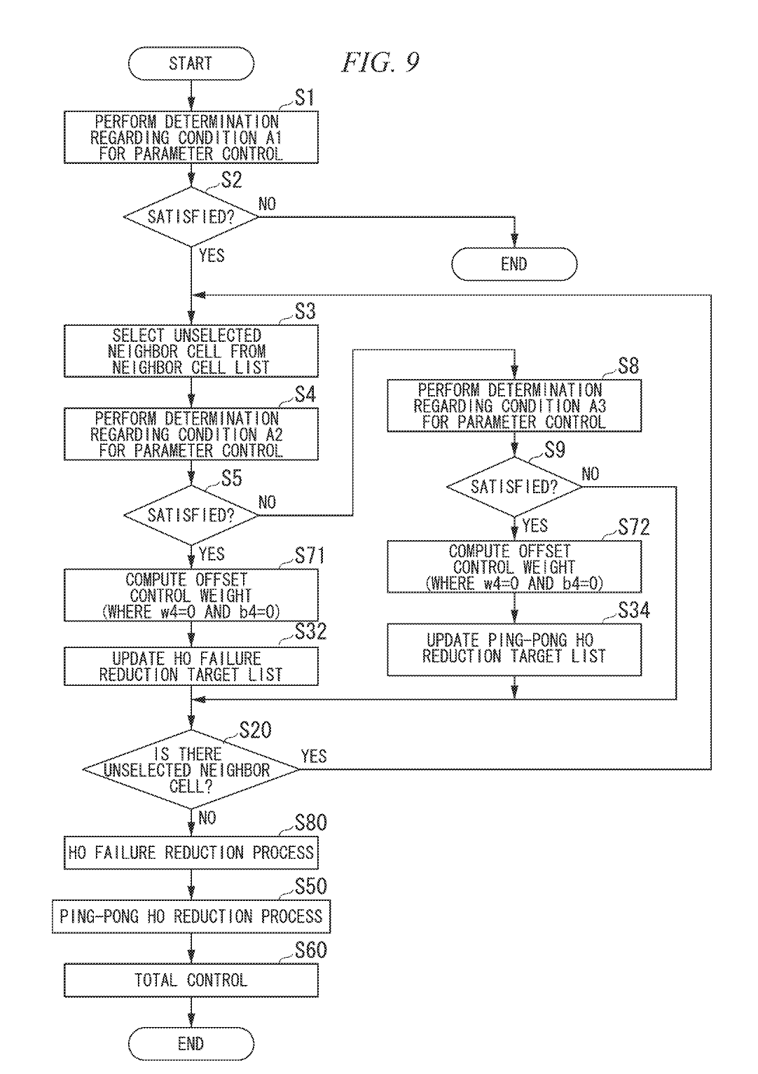

FIG. 9 shows Example 3 of the handover parameter control procedure for the present embodiment. In FIG. 9, steps corresponding to those in FIG. 5 of Example 2 are given identical reference signs.

Similar to Example 2, in Example 3, Oc(s,n) is controlled in consideration of influences imposed between neighbor cells. However, in Example 3, in Formula (2) for computing the offset control weight, w4 and b4 are each set to 0. Accordingly, the frequency of occurrence of “HO to wrong cell” when the neighbor cell n is the “reconnection cell” is not affected on the offset control weight for the neighbor cell n. This condition is employed so as to give priority to the reduction of “HO to wrong cell” when the neighbor cell n is the “target cell”.

Referring to FIG. 9, Example 3 of the handover parameter control procedure in the present embodiment will be explained. The control unit 13 starts the handover parameter control procedure shown in FIG. 9 at regular periodic intervals.

Steps S1 to S5 are basically identical to those of Example 1 (see FIG. 3). In Step S5 of Example 3, when the condition A2 for executing the parameter control is satisfied according to the determination of step S4, the operation proceeds to step S71.

Step S71: The handover failure reduction processing unit 11 computes the offset control weight for the neighbor cell n, by using Formula (2), where w4 and b4 are each set to 0.

Step S32: The handover failure reduction processing unit 11 stores the ID of the neighbor cell n selected in step S3 into a handover failure reduction target list, and then performs step S20.

In step S5, when the condition A2 for executing the parameter control is not satisfied according to the determination of step S4, the operation proceeds to step S8, which is identical to that of Example 1 (see FIG. 3).

Step S9: When the condition A3 for executing the parameter control is satisfied according to the determination of step S8, the control unit 13 then performs step S72. When the condition A3 is not satisfied, the operation proceeds to step S20.

Step S72: The ping-pong handover reduction processing unit 12 computes the offset control weight for the neighbor cell n, by using Formula (2), where w4 and b4 are each set to 0.

Step S34: The ping-pong handover reduction processing unit 12 stores the ID of the neighbor cell n selected in step S3 into a ping-pong handover reduction target list, and then performs step S20.

Step S20: The control unit 13 determines whether or not the neighbor list still includes an unselected neighbor cell. When there is an unselected neighbor cell according to the determination, the operation returns to step S3. When there is no unselected neighbor cell in the neighbor list, the operation proceeds to step S80.

Step S80: A handover failure reduction process is applied to each neighbor cell included in the handover failure reduction target list. This process will be explained later.

Step S50: A ping-pong handover reduction process is applied to each neighbor cell included in the ping-pong handover reduction target list. This process is performed using the first or second example of step S50 in Example 2.

Step S60: For all Oc(s,n) values set as output data 22, the control unit 13 performs total control, which is identical to those performed in steps S21 to S23 of Example 1 (see FIG. 4). The operation of FIG. 9 is then terminated.

### Example of Step S80

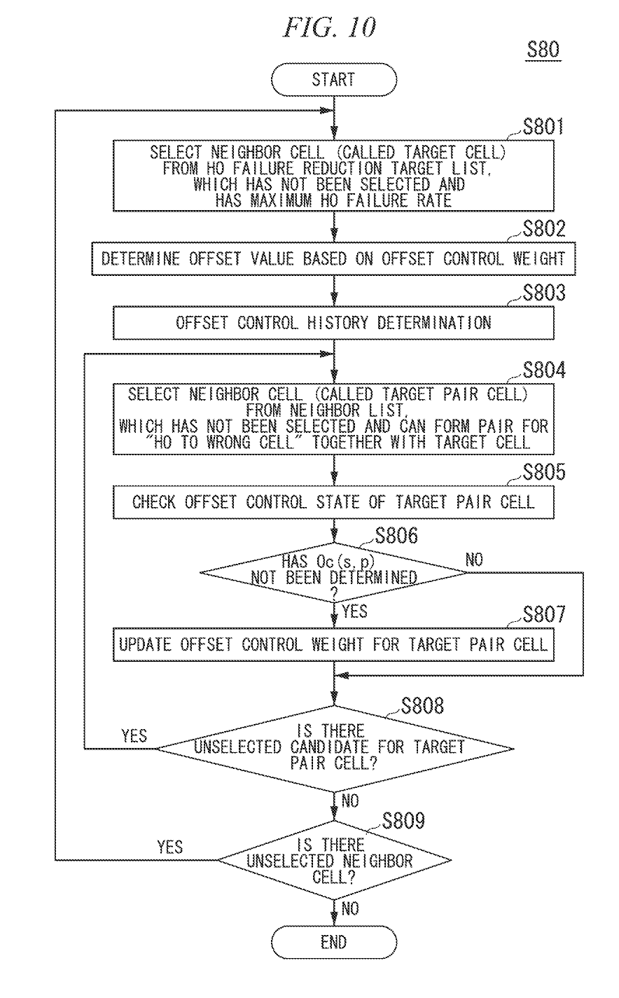

FIG. 10 shows an example of the handover failure reduction process for step S80 of FIG. 9. Referring to FIG. 10, the example of the handover failure reduction process in step S80 will be explained.

Step S801: The handover failure reduction processing unit 11 selects a neighbor cell from the handover failure reduction target list, which has not yet been selected and has the maximum failure rate for handover. The selected neighbor cell will be called “target cell n”.

Step S802: Based on the offset control weight for the target cell n, the handover failure reduction processing unit 11 determines Oc(s,n) for the target cell n. The method of determining Oc(s,n) is identical to that performed in step S7 of Example 1 (see FIG. 3).

Step S803: The control unit 13 performs an offset control history determination process which is similar to those performed in steps S12 to S19 of Example 1 (see FIG. 3).

Step S804: The handover failure reduction processing unit 11 selects a neighbor cell from the neighbor (cell) list, which has not yet been selected and can form a pair for “HO to wrong cell” together with the target cell n. The selected neighbor cell will be called “target pair cell p”.

Step S805: The handover failure reduction processing unit 11 checks the offset control state of the target pair cell p.

Step S806: According to the check performed in step S805, when Oc(s,p) for the target pair cell p has been determined, the handover failure reduction processing unit 11 then performs step S808. When Oc(s,p) for the target pair cell p has not yet been determined, the operation proceeds to step S807.

Step S807: The handover failure reduction processing unit 11 updates the offset control weight for the target pair cell p.

The method of updating the offset control weight in step S807 will be explained.

In the relevant method for the target cell n and the target pair cell p, the offset control weight for the target pair cell p is updated based on the following control criterion (d) relating to “HO to wrong cell”, which is defined in consideration of the control direction for Oc(s,n) of the target cell n.

(d) When the control direction for Oc(s,n) of the target cell n is to increase from the current value, “k1×(w4×(frequency of occurrence of “HO to wrong cell” when the target cell n is the “target cell” and the target pair cell p is the “reconnection cell”)+b4)” is added to the offset control weight for the target pair cell p.

Step S808: The handover failure reduction processing unit 11 determines whether or not the neighbor list includes an unselected candidate for the target pair cell. When the neighbor list still includes an unselected candidate for the target pair cell, the operation returns to step S804. When there is no unselected candidate for the target pair cell in the neighbor list, the operation proceeds to step S809.

Step S809: The handover failure reduction processing unit 11 determines whether or not the handover failure reduction target list includes an unselected neighbor cell. When the handover failure reduction target list still includes an unselected neighbor cell, the operation returns to step S801. When there is no unselected neighbor cell in the handover failure reduction target list, the operation of FIG. 10 is terminated.

Also for Example 1 or 2, a simple variation in which w4 and b4 in Formula (2) (for computing the offset control weight) are each set to 0 can produce an effect to give priority to the reduction of “HO to wrong cell” when the neighbor cell n is the “target cell”.

As described above, the present embodiment can totally reduce handover failure events (i.e., first-type and second-type handover failure events) which have opposite handover parameter control directions, thereby improving stability for the handover parameter control. In addition, ping-pong handovers can also be reduced.

While preferred embodiments of the present invention have been described and illustrated above, it should be understood that these are exemplary embodiments of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

For example, although the above-described embodiment employs an LTE system, the present invention can be applied to other cellular systems.

A program for executing the steps of each specific example may be stored in a computer readable storage medium, and the program stored in the storage medium may be loaded and executed on a computer system, so as to perform the handover parameter control operation. Here, the computer system may have hardware resources which include an OS and peripheral devices.

The above computer readable storage medium is a storage device, for example, a portable medium such as a flexible disk, a magneto optical disk, a ROM, a writable and nonvolatile memory (e.g., flash memory), or a DVD (digital versatile disk), or a memory device such as a hard disk built in a computer system.

The computer readable storage medium also includes a device for temporarily storing the program, such as a volatile storage medium (e.g., DRAM (dynamic random access memory)) in a computer system which functions as a server or client and receives the program via a network (e.g., the Internet) or a communication line (e.g., a telephone line).

The above program, stored in a memory device of a computer system, may be transmitted via a transmission medium or by using transmitted waves passing through a transmission medium to another computer system. The transmission medium for transmitting the program has a function of transmitting data, and is, for example, a (communication) network such as the Internet or a communication line such (e.g., a telephone line).

In addition, the program may execute a part of the above-explained functions. The program may also be a “differential” program so that the above-described functions can be executed by a combination program of the differential program and an existing program which has already been stored in the relevant computer system.

What is claimed is:

1. A handover parameter control apparatus provided in each cell of a cellular system which has a handover condition in which if power received by a mobile terminal from a neighbor base station and power received by the mobile terminal from an access base station, to which the mobile terminal is connected, have a power difference greater than or equal to a threshold, then the mobile terminal executes handover of the mobile terminal from an access cell belonging to the access base station to a neighbor cell belonging to the neighbor base station, the apparatus comprising:
a threshold control weight computation unit that computes a threshold control weight which indicates a control direction for the threshold so as to reduce handover failures, by using:
a frequency of occurrence of first-type handover failure events which reduces by increasing the threshold; and
a frequency of occurrence of second-type handover failure events which reduces by decreasing the threshold; and
a threshold determination unit that determines the threshold based on the threshold control weight.

2. The handover parameter control apparatus in accordance with claim 1, wherein:
the first-type handover failure events include those called “Too early HO” and those called “HO to wrong cell” when the neighbor cell is a cell called “target cell” as a destination of the handover; and
the second-type handover failure events include those called “Too late HO” and those called “HO to wrong cell” when the neighbor cell is a cell called “reconnection cell” to which the mobile terminal is reconnected.

3. The handover parameter control apparatus in accordance with claim 2, wherein:
the first-type handover failure events further include those called “ping-pong handover”.

4. The handover parameter control apparatus in accordance with claim 1, wherein the threshold control weight computation unit:
computes for each neighbor cell:
a first weight assigned to each control direction for the first-type handover failure events; and
a second weight assigned to each control direction for the second-type handover failure events;
computes a synthesized weight for each of combinations between the control directions for the threshold with respect to all neighbor cells, by synthesizing the first weight and the second weight for all neighbor cells; and
selects one of said combinations which has the maximum synthesized weight.

5. The handover parameter control apparatus in accordance with claim 2, wherein:
the greater the failure rate for handover of each neighbor cell, the earlier the execution timing of the threshold control for the relevant neighbor cell; and
for a second neighbor cell which forms a pair relating to the “HO to wrong cell” together with a first neighbor cell, the threshold control weight computation unit computes the threshold control weight for the second neighbor cell based on a control criterion for the “HO to wrong cell” defined in accordance with the control direction of the threshold of the first neighbor cell.

6. The handover parameter control apparatus in accordance with claim 1, wherein:
the second-type handover failure events include those called “HO to wrong cell” when the neighbor cell is a cell called “reconnection cell” to which the mobile terminal is reconnected; and
the threshold control weight computation unit computes the threshold control weight by setting the frequency of occurrence of “HO to wrong cell” to 0.

7. The handover parameter control apparatus in accordance with claim 1, wherein:
the threshold determination unit updates the threshold so as to reduce ping-pong handover only when the threshold control weight is assigned to a control direction for increasing the threshold.

8. The handover parameter control apparatus in accordance with claim 7, wherein:
the higher the frequency of occurrence of the ping-pong handover for each neighbor cell, the earlier the execution timing of the threshold control for the relevant neighbor cell so as to reduce the ping-pong handover; and
for a second neighbor cell which forms a pair relating to the “HO to wrong cell” together with a first neighbor cell, the threshold control weight computation unit computes the threshold control weight for the second neighbor cell based on a control criterion for the “HO to wrong cell” defined in accordance with the control direction of the threshold of the first neighbor cell.

9. A handover parameter control method of controlling a handover parameter for each cell of a cellular system which has a handover condition in which if power received by a mobile terminal from a neighbor base station and power received by the mobile terminal from an access base station, to which the mobile terminal is connected, have a power difference greater than or equal to a threshold, then the mobile terminal executes handover of the mobile terminal from an access cell belonging to the access base station to a neighbor cell belonging to the neighbor base station, the method comprising:
a step that is executed by a threshold control weight computation unit and computes a threshold control weight which indicates a control direction for the threshold so as to reduce handover failures, by using:
a frequency of occurrence of first-type handover failure events which reduces by increasing the threshold; and
a frequency of occurrence of second-type handover failure events which reduces by decreasing the threshold; and
a step that is executed by a threshold determination unit and determines the threshold based on the threshold control weight.

10. A non-transitory computer-readable storage medium which stores a computer program used for executing a procedure of controlling a handover parameter for each cell of a cellular system which has a handover condition in which if power received by a mobile terminal from a neighbor base station and power received by the mobile terminal from an access base station, to which the mobile terminal is connected, have a power difference greater than or equal to a threshold, then the mobile terminal executes handover of the mobile terminal from an access cell belonging to the access base station to a neighbor cell belonging to the neighbor base station, the program making a computer execute:
a step that computes a threshold control weight which indicates a control direction for the threshold so as to reduce handover failures, by using:
a frequency of occurrence of first-type handover failure events which reduces by increasing the threshold; and
a frequency of occurrence of second-type handover failure events which reduces by decreasing the threshold; and
a step that determines the threshold based on the threshold control weight.
